(19) United States
(12) Patent Application Publication
(10) Pub. No.: US 2013/0015836 A1
(43) Pub. Date: Jan. 17, 2013

(54) LOW NOISE STEP-DOWN CONVERTER AND LOW NOISE VOLTAGE SUPPLY ASSEMBLY

(71) Applicants: Chiu-Hsien Chang, New Taipei City (TW); Ming-Feng Wu, New Taipei City (TW); Nai-Shuo Cheng, New Taipei City (TW); Yen-Ting Chen, New Taipei City (TW)

(72) Inventors: Chiu-Hsien Chang, New Taipei City (TW); Ming-Feng Wu, New Taipei City (TW); Nai-Shuo Cheng, New Taipei City (TW); Yen-Ting Chen, New Taipei City (TW)

(73) Assignee: Wistron Corporation, New Taipei City (TW)

(21) Appl. No.: 13/232,754

(22) Filed: Sep. 14, 2011

(30) Foreign Application Priority Data
Jul. 13, 2011 (TW) 100124838

(51) Int. Cl. H02M 3/156

(52) U.S. Cl. 323/351

(57) ABSTRACT

A low noise step-down converter includes a rectified voltage output, a pulse generator, a rectifying diode, a rectifying inductor, a rectifying capacitor, and an impedance element. The rectified voltage output is provided for outputting a converted voltage. The pulse generator includes a pulse wave output. The pulse generator receives an input voltage and outputs a pulse wave through the pulse wave output. The rectifying diode is reversely coupled to the pulse wave output. One end of the rectifying inductor is connected to the pulse wave output for receiving the pulse wave while the other is connected to the rectified voltage output. One end of the rectifying capacitor is connected to the rectified voltage output, and the other end is electrically grounded. The impedance element at least provides resistance impedance and inductance impedance, wherein the rectifying diode and the impedance element are connected in series and are electrically grounded.

### CROSS-REFERENCES TO RELATED APPLICATIONS

This non-provisional application claims priority under 35 U.S.C. §119(a) on Patent Application No. 100124838 filed in Taiwan, R.O.C. on Jul. 13, 2011, the entire contents of which are hereby incorporated by reference.

### BACKGROUND OF THE INVENTION

1. Technical Field

This disclosure relates to a DC-DC converter, and more particularly to a low noise step-down converter and a low noise voltage supply assembly having the converter.

2. Related Art

Please refer to FIG. 1, in which a typical non-synchronous rectification buck converter is shown. The buck converter is a DC-DC converter commonly used in the prior art. In a buck converter, a fast changeover switch, such as a transistor switch, is employed to convert a voltage output of a DC voltage source V into a discontinuous current mode to output, for example, a pulse-width-modulation (PWM) signal. Through rectification of an inductor 20, a capacitor 30 and a diode 40, the discontinuous current mode to output is then rectified into a low-voltage current and transferred to a load circuit L.

The fast changeover switch 10 continuously performs ON and OFF operations, so that the DC voltage source V can output a discontinuous current by means of the fast changeover switch 10. Under the interaction of the discontinuous current and the input impedance, a ripple voltage and an electromagnetic interference (EMI) occur. If the intensity of the ripple voltage and the intensity of the EMI exceed an allowed intensity threshold of the load circuit L, the operation of the load circuit L will be affected, and even worse, the load circuit L would be damaged. Even if the load circuit L is not apparently influenced, the EMI influences the operation of the other electronic apparatus around the load circuit L.

In view of the problem that the output of the converter may influence the load circuit L, U.S. Patent No. 5,124,873 discloses a surge suppression circuit, in which a Zener diode is reversely connected to an output end of the voltage source and the output end is bypassed and grounded through the Zener diode. When a high-voltage surge is output to the load circuit L from the voltage source, the Zener diode is reversely conducted as the reverse bias exceeds the breakdown voltage, and thus the high-voltage surge is bypassed to the ground line and then is eliminated. However, U.S. Patent No. 5,124,873 is directed mainly toward solving the problem that the voltage source is unstable or the high-voltage surge is incurred by the externally introduced high voltage, while the ripple voltage and the EMI of the DC-DC converter have not been solved.

In the specification of U.S. Patent No. 7,038,899, a filter circuit is cited, which is provided for filtering or suppressing a noise output by an amplifier. However, the ripple voltage still has not been solved by this cited reference, and the ripple voltage and the EMI of the DC-DC converter are not solved.

### SUMMARY

In view of the ripple voltage and the EMI problems in the DC-DC converter, this disclosure is directed a low noise step-down converter, which suppresses the ripple voltage and reduces the EMI.

According to the claimed invention, a low noise step-down converter is provided for receiving an input voltage, converting the input voltage, and outputting a converted voltage to a load circuit. The low noise step-down converter includes a rectified voltage output, a pulse generator, a rectifying diode, a rectifying inductor, a rectifying capacitor, and an impedance element.

The rectified voltage output is provided for outputting a converted voltage. The pulse generator includes a pulse wave output, and the pulse generator is provided for receiving an input voltage and outputting a pulse wave through the pulse wave output. The rectifying diode is reversely coupled to the pulse wave output, so that the rectifying diode is reversely biased by a duty cycle of the pulse wave. One end of the rectifying inductor is connected to the pulse wave output for receiving the pulse, and the other end of the rectifying inductor is connected to the rectified voltage output. One end of the rectifying capacitor is connected to the rectified voltage output, and the other end of the rectifying capacitor is electrically grounded. The impedance element at least provides resistance impedance and inductance impedance, wherein the rectifying diode and the impedance element are connected in series and are electrically grounded.

By matching the impedance element with the input impedance of the load circuit, the low noise step-down converter of this disclosure effectively suppresses the ripple voltage and eliminates the EMI.

In view of the ripple voltage and the EMI problems in the DC-DC converter, this disclosure is directed to a low noise voltage supply assembly, in which the output has the advantages of low ripple voltage intensity and low EMI intensity.

According to the claimed invention, a low noise voltage supply assembly is provided for outputting a converted voltage to a load circuit. The low noise voltage supply assembly includes a rectified voltage output, a pulse output device, a rectifying inductor, a rectifying capacitor, a rectifying diode, and an impedance element.

The rectified voltage output is provided for outputting a converted voltage. The pulse output device includes a pulse wave output for outputting a pulse wave. One end of the rectifying inductor is connected to the pulse wave output for receiving the pulse wave, and the other end of the rectifying inductor is connected to the rectified voltage output. One end of the rectifying capacitor is connected to the rectified voltage output, and the other end of the rectifying capacitor is electrically grounded. The rectifying diode is reversely coupled to the pulse wave output, so that the rectifying diode is reversely biased by a duty cycle of the pulse wave. The impedance element at least provides resistance impedance and inductance impedance, and the rectifying diode and the impedance element are connected in series and are electrically grounded.

By matching the impedance element and the input impedance of the load circuit, the converted voltage output by the low noise voltage supply assembly of this disclosure has the advantages of low ripple voltage intensity and low EMI intensity.

The claimed invention can effectively suppress the ripple voltage, thereby avoiding the ripple voltage from damaging the load circuit. Meanwhile, the suppression on the ripple voltage may also effectively reduce the intensity of EMI. Consequently, the voltage supply solution provided by the embodiments of this disclosure has the characteristic of low noise.

### BRIEF DESCRIPTION OF THE DRAWINGS

The present invention will become more fully understood from the detailed description given herein below for illustration only, and thus not limitative of the present invention, wherein:

FIG. 1 is a circuit diagram of a DC-DC converter in the prior art;

FIG. 2 is a circuit diagram according to a first embodiment;

FIG. 3 and FIG. 4 are schematic views of a current flowing according to the circuit in FIG. 2 in different half-cycles;

FIG. 5 is a relation diagram of a noise intensity output by the converter and a switching frequency according to the prior art;

FIG. 6 is a relation diagram of input impedance and a switching frequency;

FIG. 7 is a relation diagram of a noise intensity output by the circuit and a switching frequency according to the first embodiment;

FIG. 8 is a circuit diagram according to a second embodiment;

FIG. 9 is a circuit diagram of an example according to the second embodiment of this disclosure; and

FIG. 10 is a circuit diagram according to a third embodiment of this disclosure.

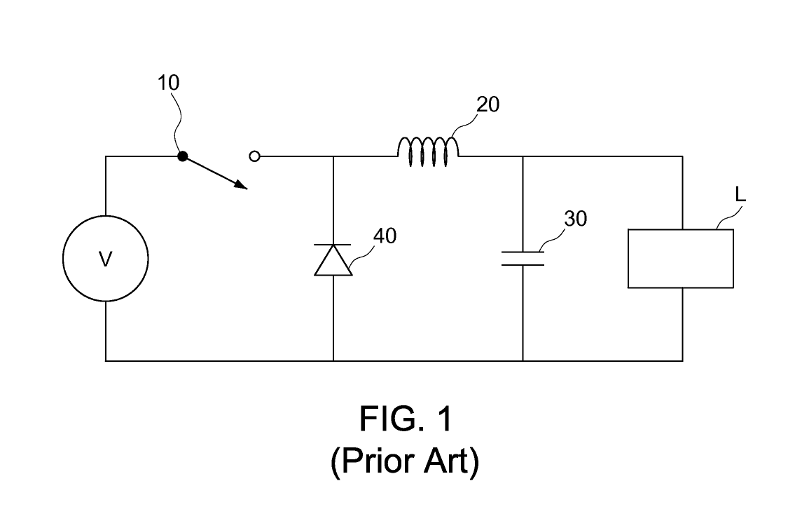

### DETAILED DESCRIPTION

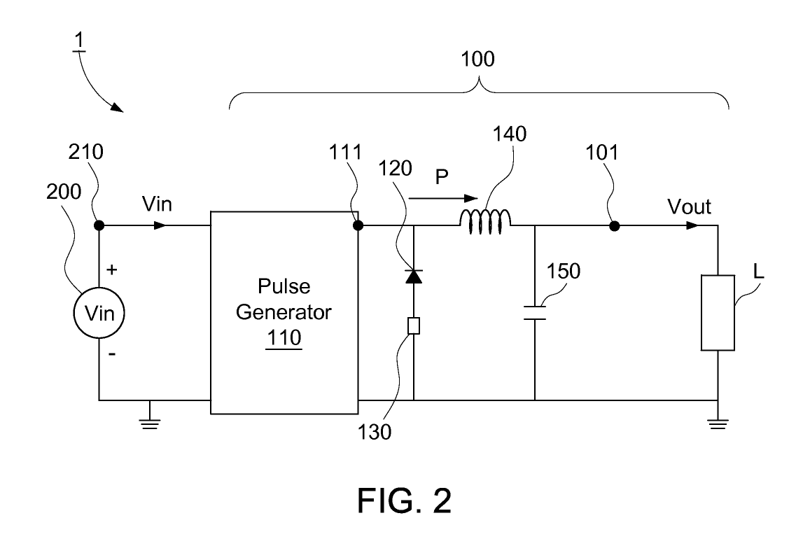

Please refer to FIG. 2, a low noise voltage supply assembly 1 according to a first embodiment is shown, which includes a low noise step-down converter 100 and a direct current (DC) voltage source 200.

As shown in FIG. 2, the DC voltage source 200 provides an input voltage Vin and outputs the input voltage Vin to the low noise step-down converter 100 through a direct current (DC) voltage supply end 210 of the DC voltage source 200.

The low noise step-down converter 100 receives the input voltage Vin from the DC voltage supply end 210 and converts the input voltage Vin into a converted voltage Vout with a relative low voltage. Then, the low noise step-down converter 100 outputs the converted voltage Vout to a load circuit L through a rectified voltage output 101.

As shown in FIG. 2, the low noise step-down converter 100 further includes a pulse generator 110, a rectifying diode 120, an impedance element 130, a rectifying inductor 140, and a rectifying capacitor 150.

As shown in FIG. 2, the pulse generator 110 is electrically connected to the DC voltage supply end 210 to receive the input voltage Vin and periodically switch the output to be ON and OFF, so that the input voltage Vin is output as a pulse wave P. The pulse generator 110 includes a pulse wave output 111 for outputting the pulse wave P. The input voltage Vin DC provided by the voltage source 200 is constant. Being switched by the pulse generator 110, the input voltage Vin is converted into a pulse-width-modulation (PWM) signal, such as the pulse wave P.

As shown in FIG. 2, one end of the rectifying diode 120 is coupled to the pulse wave output 111, and the other end of the rectifying diode 120 is electrically grounded indirectly via the impedance element 130, so that a forward bias direction of the rectifying diode 120 is pointed to the pulse wave output 111 from the electrically grounded end. In more details, the rectifying diode 120 is reversely coupled to the pulse wave output 111, so that the rectifying diode 120 is reversely biased by a duty cycle of the pulse wave P.

In an example, the rectifying diode 120 is a Schottky diode. The reverse recovery time of the Schottky diode is merely a few picoseconds (ps), that is, the time for the Schottky diode to switch from a conduction state that allows the forward bias current to pass through to the non-conduction state in which the reverse bias exists is merely a few ps, thereby reducing the problems incurred by the reverse current.

As shown in FIG. 2, the impedance element 130 at least provides resistance impedance and inductance impedance. The rectifying diode 120 and the impedance element 130 are connected in series and are electrically grounded in series.

As shown in FIG. 2, in an example, the impedance element 130 is a ferrite bead that has both the good resistance impedance and the good inductance impedance. Meanwhile, the ferrite bead is a single element with small volume, which is beneficial for the layout design of the circuit, and the ferrite bead included has a good tolerance, thereby extending the usability lifespan.

One end of the rectifying inductor 140 is connected to the pulse wave output 111 to receive the pulse wave P, and the other end of the rectifying inductor 140 is connected to the rectified voltage output 101. One end of the rectifying capacitor 150 is connected to the rectified voltage output 101 and the other end of the rectifying capacitor 150 is electrically grounded.

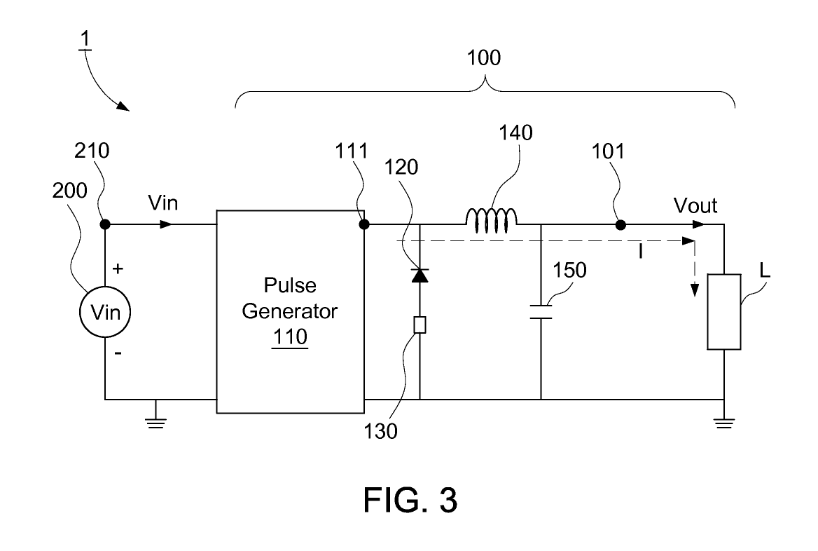

As shown in FIG. 3, when the pulse wave P signal output by the pulse generator 110 is in a high-level half-cycle, the DC voltage source 200 directly supplies a first current I to the load circuit L through the pulse generator 110 and the rectifying inductor 140. Meanwhile, the rectifying capacitor 150 is charged. At this time, since the current output by the DC voltage source 200 also charges the rectifying capacitor 150, the first current I is ascent with the time; that is, the rectifying capacitor 150 is gradually saturated and reduces the current passing through the rectifying capacitor 150. The rectifying diode 120 is reversely biased, so that no current passes through the rectifying diode 120 and the impedance element 130.

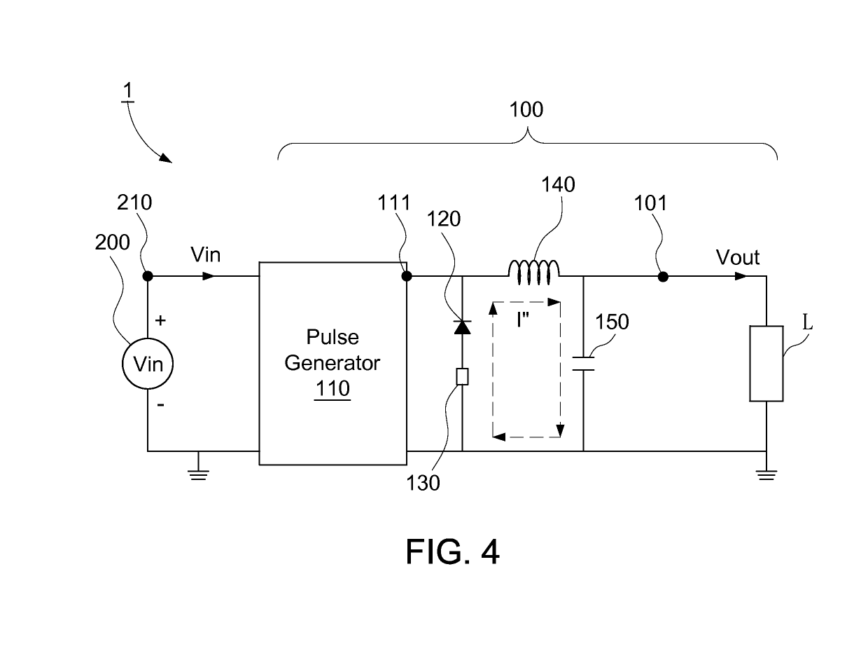

As shown in FIG. 4, when the pulse wave P signal output by the pulse generator 110 is in a low-level half-cycle, the rectifying capacitor 150 is discharged, and thus the rectifying diode 120 is forwardly biased to form a second current I″ supplied to the load circuit L. Since the second current I″ is supplied by the rectifying capacitor 150, the second current I″ is descent with the time.

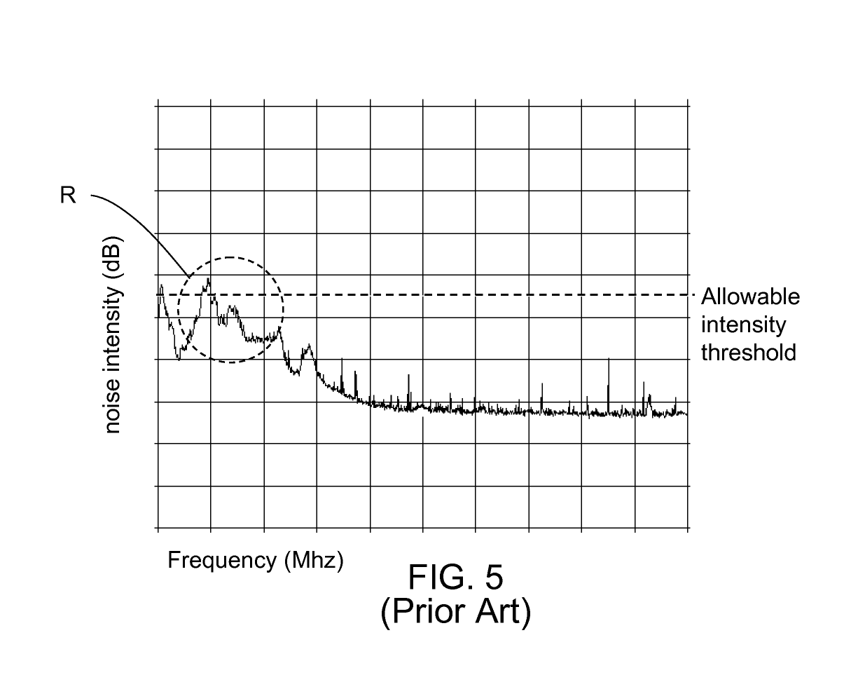

As shown in FIG. 5, the pulse wave P signal is continuously switched between the high and low levels at a high frequency. In the situation that the impedance element 130 is not connected to the rectifying diode 120 in series, the input voltage Vin contains a ripple voltage R and generates Electromagnetic interference (EMI), thereby influencing the operation of the load circuit L.

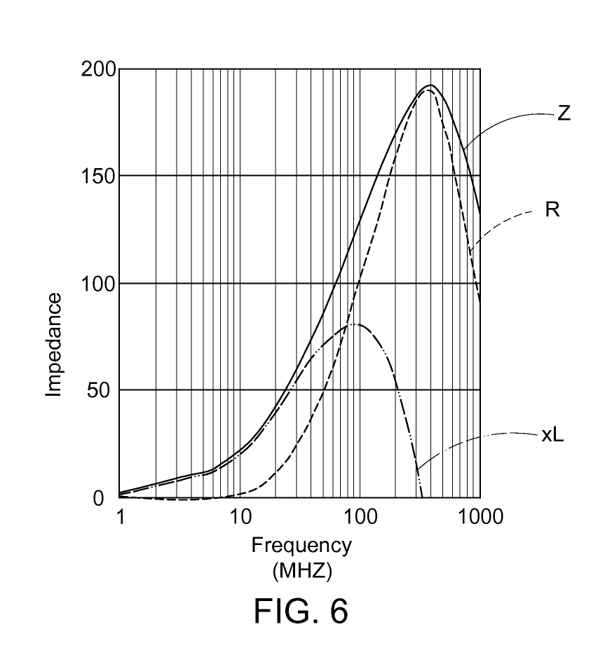

As shown in FIG. 6, the generation of the ripple voltage R is mainly influenced by the frequency of the pulse wave P signal and the input impedance of the load circuit L. Generally, the frequency of the pulse wave P signal is constant, so that the magnitude of the ripple voltage R has to be changed by changing the input impedance Z of the load circuit L. As shown in FIG. 5, if the input impedance Z of the load circuit L is expressed in a complex, the input impedance Z becomes a number consisting of a real part expressing the resistance impedance R and an imaginary part expressing the inductance impedance xL. The magnitude of the ripple voltage R is mainly influenced by the inductance impedance xL expressed as the imaginary part. Here, the imaginary part inductance impedance xL corresponding to the resistance impedance and the inductance impedance provided by the impedance element 130 may be found according to the frequency of the pulse wave P signal, thereby selecting the appropriate impedance element 130.

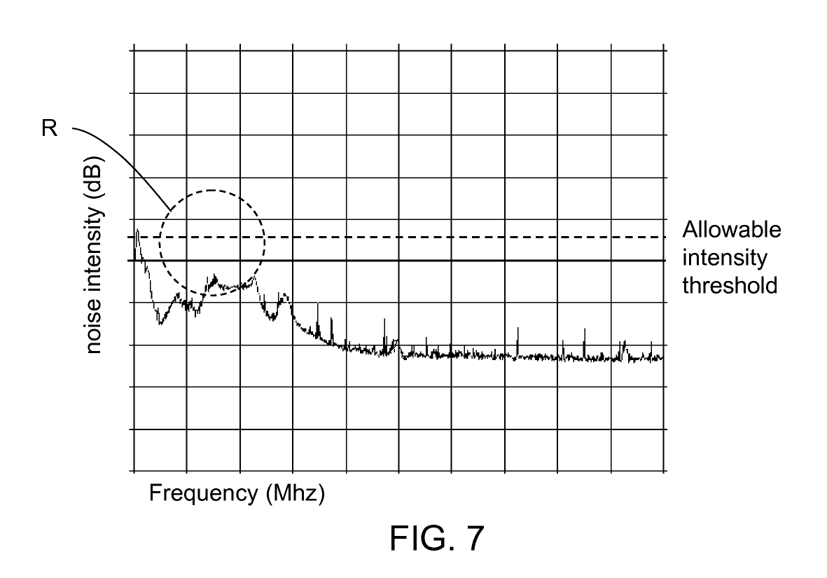

As shown in FIG. 7, after the appropriate impedance element 130 is connected to the rectifying diode 120 in series, the ripple voltage R can be lowered to a value smaller than an allowable intensity threshold.

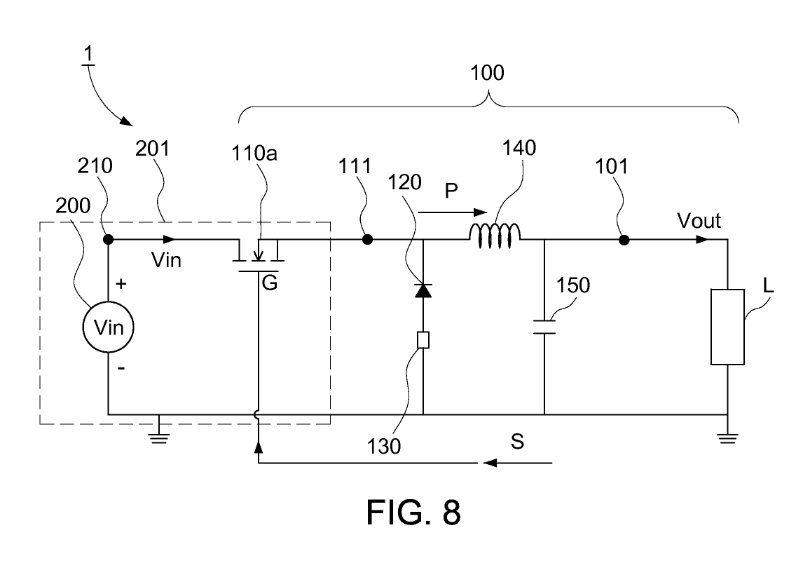

As shown in FIG. 8, a low noise voltage supply assembly 1 according to a second embodiment of this disclosure includes a rectified voltage output 101. The low noise voltage supply assembly 1 outputs a converted voltage Vout to a load circuit L through the rectified voltage output 101. The low noise voltage supply assembly 1 further includes a pulse output device 201, a rectifying diode 120, an impedance element 130, a rectifying inductor 140 and a rectifying capacitor 150.

As shown in FIG. 8, the pulse output device 201 includes a pulse wave output 111a for outputting a pulse wave P. The pulse output device 201 includes a DC voltage source 200 and a pulse generator 110a. The DC voltage source 200 includes a DC voltage supply end 210, and the DC voltage source 200 provides an input voltage Vin through the DC voltage supply end 210.

The pulse generator 110a can be combined with the rectifying diode 120, the impedance element 130, the rectifying inductor 140 and the rectifying capacitor 150, so as to form the low noise step-down converter 100 of the first embodiment. In an example, the pulse generator 110a is a transistor switch disposed between the DC voltage supply end 210 and the pulse wave output 111.

As shown in FIG. 8, serving as the pulse generator 110a, a gate G of the transistor switch is connected to an oscillator or a control signal source to receive a periodical switching signal S. Triggered by the periodical switching signal S, the transistor switch periodically switches the DC voltage supply end 210 connecting to the pulse wave output 111 or disconnecting from the pulse wave output 111, thereby forming the pulse wave P and outputting the pulse wave P from the pulse wave output 111. Since the input voltage Vin provided by the DC voltage source 200 is constant, the bandwidth of the duty cycle is determined through the switching of the pulse generator 110a, the pulse wave P is therefore the PWM signal.

As shown in FIG. 8, an example of the rectifying diode 120 is a Schottky diode which is reversely coupled to the pulse wave output 111, so that the rectifying diode 120 is reversely biased by a duty cycle of the pulse wave P.

An example of the impedance element 130 is a ferrite bead which at least provides resistance impedance and inductance impedance. The rectifying diode 120 and the impedance element 130 are connected in series and are electrically grounded. In one or more embodiment, the impedance element 130 is connected to the rectifying diode 120 in series, so that the rectifying diode 120 is electrically grounded by the impedance element 130. The inductance impedance is selected according to the switching frequency of the pulse wave P, and the inductance impedance matching the load circuit L is found to compensate the imaginary part of the input impedance, thereby reducing the ripple voltage in the output voltage Vin.

One end of the rectifying inductor 140 is connected to the pulse wave output 111 to receive the pulse wave P, and the other end of the rectifying inductor 140 is connected to the rectified voltage output 101. One end of the rectifying capacitor 150 is connected to the rectified voltage output 101 and the other end of the rectifying capacitor 150 is electrically grounded.

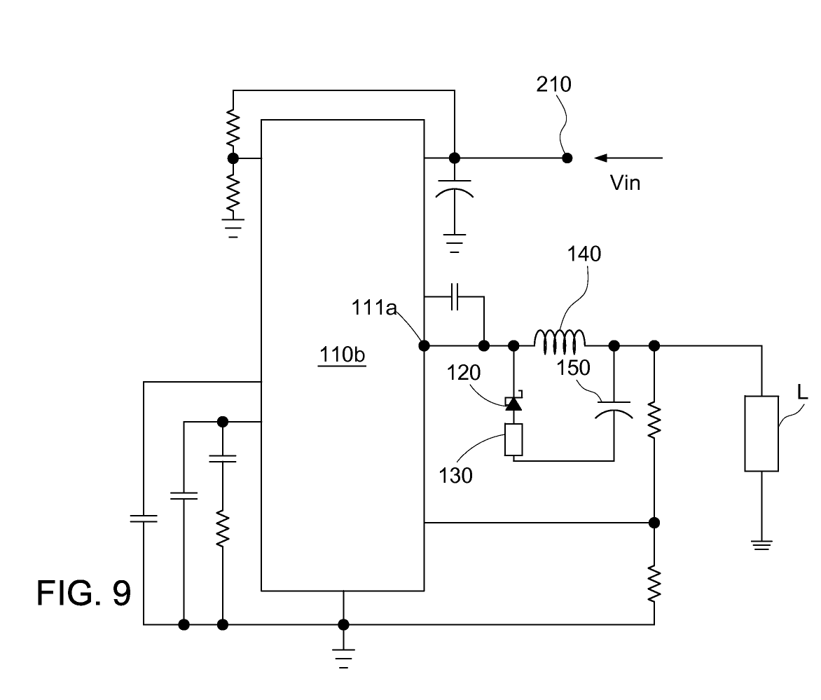

As shown in FIG. 9, when the second embodiment is applied in commercial usage, the pulse generator 110a can be integrated in a power chip 110b, and the pulse wave output 111a is a pin of the power chip for being connected to the impedance element 130, the rectifying inductor 140, and the rectifying capacitor 150.

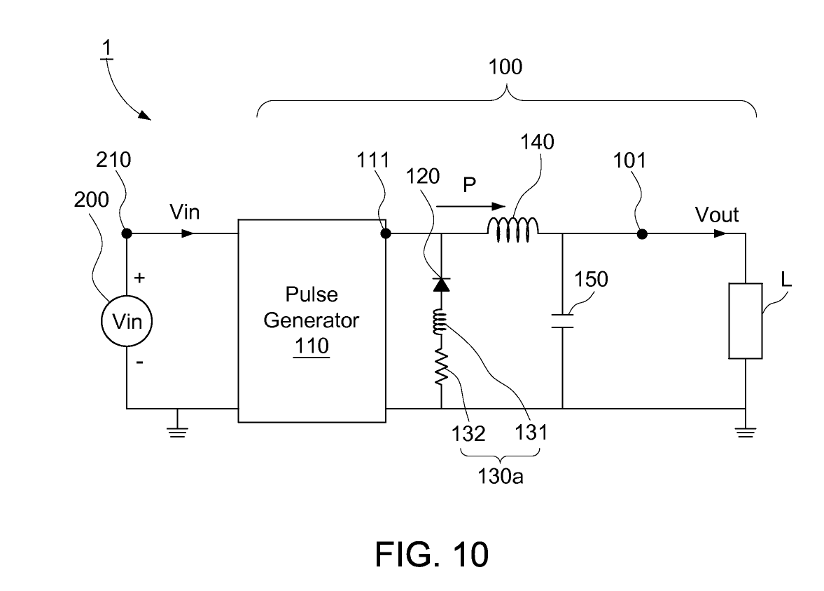

As shown in FIG. 10, a low noise voltage supply assembly 1 according to a third embodiment of this disclosure provides an implementation of the impedance element 130a, which can be combined in the circuit of all the other embodiments of this disclosure, thereby realizing the changes of the low noise voltage supply assembly 1 and the low noise step-down converter 100.

In the third embodiment, the impedance element 130a includes a match inductor 131 and a match resistor 132. The match inductor 131 and the match resistor 132 are connected in series and are connected to the rectifying diode 120 in series. In this embodiment, the independent match inductor 131 may realize quickly finding the inductance impedance matching the load circuit L to compensate the imaginary part of the input impedance, thereby reducing the ripple voltage in the output voltage Vin.

According to the embodiments of this disclosure, the ripple voltage R is effectively suppressed by selecting a matching impedance element 130/130a, thereby avoiding the ripple voltage R from damaging the load circuit L. Meanwhile, the suppression on the ripple voltage R may also effectively reduce the intensity of EMI. Consequently, the voltage supply solution provided by the embodiments of this disclosure has the characteristic of low noise.

While this disclosure has been described by the way of example and in terms of the preferred embodiments, it is to be understood that the invention need not to be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A low noise step-down converter, for receiving an input voltage, converting the input voltage, and outputting a converted voltage to a load circuit, comprising:
a rectified voltage output, for outputting the converted voltage;
a pulse generator, comprising a pulse wave output; wherein the pulse generator is provided for receiving the input voltage and outputting a pulse wave through the pulse wave output;
a rectifying diode, reversely coupled to the pulse wave output, so that the rectifying diode is reversely biased by a duty cycle of the pulse wave;
a rectifying inductor, having one end connected to the pulse wave output to receive the pulse wave and the other end connected to the rectified voltage output;
a rectifying capacitor, having one end connected to the rectified voltage output and the other end electrically grounded; and
an impedance element, at least providing resistance impedance and inductance impedance, wherein the rectifying diode and the impedance element are connected in series and are electrically grounded.

2. The low noise step-down converter as claimed in claim 1, wherein the pulse is a pulse-width-modulation signal.

3. The low noise step-down converter as claimed in claim 2, wherein one end of the rectifying diode is coupled to the pulse wave output and the other end of the rectifying diode is electrically grounded indirectly via the impedance element.

4. The low noise step-down converter as claimed in claim 3, wherein the impedance element is a ferrite bead.

5. The low noise step-down converter as claimed in claim 4, wherein the rectifying diode is a Schottky diode.

6. The low noise step-down converter as claimed in claim 5, wherein the pulse generator comprises:
a transistor switch, disposed between a direct current voltage supply end and the pulse wave output, for periodically switching the direct current voltage supply end connecting to the pulse wave output or disconnecting from the pulse wave output.

7. The low noise step-down converter as claimed in claim 3, wherein the impedance element comprises a match inductor and a match resistor, in which the match inductor and the match resistor are connected in series and are connected to the rectifying diode in series.

8. The low noise step-down converter as claimed in claim 7, wherein the pulse generator comprises:
a transistor switch, disposed between a direct current voltage supply end and the pulse wave output, for periodically switching the direct current voltage supply end connecting to the pulse wave output or disconnecting from the pulse wave output.

9. The low noise step-down converter as claimed in claim 8, wherein the rectifying diode is a Schottky diode.

10. A low noise voltage supply assembly, for outputting a converted voltage to a load circuit, comprising:
a rectified voltage output, for outputting the converted voltage;
a pulse output device, comprising a pulse wave output for outputting a pulse wave;
a rectifying inductor, having one end connected to the pulse wave output to receive the pulse wave and the other end connected to the rectified voltage output;
a rectifying capacitor, having one end connected to the rectified voltage output and the other end electrically grounded;
a rectifying diode, reversely coupled to the pulse wave output, so that the rectifying diode is reversely biased by a duty cycle of the pulse wave; and
an impedance element, at least providing resistance impedance and inductance impedance, wherein the rectifying diode and the impedance element are connected in series and are electrically grounded.

11. The low noise voltage supply assembly as claimed in claim 10, wherein the impedance element is a ferrite bead.

12. The low noise voltage supply assembly as claimed in claim 11, wherein the pulse is a pulse-width-modulation signal.

13. The low noise voltage supply assembly as claimed in claim 12, wherein the pulse output device comprises:
a direct current voltage source, comprising a direct current voltage supply end for providing the input voltage; and
a pulse generator, comprising the pulse wave output; wherein the pulse generator is provided for periodically switching the direct current voltage supply end connecting to the pulse wave output or disconnecting from the pulse wave output.

14. The low noise voltage supply assembly as claimed in claim 13, wherein the pulse generator comprises:
a transistor switch, disposed between the direct current voltage supply end and the pulse wave output, for periodically switching the direct current voltage supply end connecting to the pulse wave output or disconnecting from the pulse wave output.

15. The low noise voltage supply assembly as claimed in claim 14, wherein one end of the rectifying diode is coupled to the pulse wave output and the other end of the rectifying diode is electrically grounded indirectly via the impedance element.

16. The low noise voltage supply assembly as claimed in claim 14, wherein the rectifying diode is a Schottky diode.

17. The low noise voltage supply assembly as claimed in claim 10, wherein the impedance element comprises a match inductor and a match resistor, in which the match inductor and the match resistor are connected in series and are connected to the rectifying diode in series.

18. The low noise voltage supply assembly as claimed in claim 17, wherein the rectifying diode is a Schottky diode having one end coupled to the pulse wave output and the other end of the rectifying diode electrically grounded indirectly via the impedance element.

19. The low noise voltage supply assembly as claimed in claim 18, wherein the pulse is a pulse-width-modulation signal.

20. The low noise voltage supply assembly as claimed in claim 19, wherein the pulse output device comprises:
a direct current voltage source, comprising a direct current voltage supply end for providing the input voltage; and
a transistor switch, disposed between a direct current voltage supply end and the pulse wave output, for periodically switching the direct current voltage supply end connecting to the pulse wave output or disconnecting from the pulse wave output.
